(19) United States
(12) Patent Application Publication
(10) Pub. No.: US 2026/0015212 A1
(43) Pub. Date: Jan. 15, 2026

(54) LIFTING MECHANISM FOR AN APPARATUS FOR LIFTING CONTRUCTION BOARDS, LIFTING APPARATUS COMPRISING SUCH A MECHANISM, LIFTING METHOD USING SUCH AN APPARATUS

(71) Applicant: EDMA, Puget-Sur-Argens (FR)

(72) Inventor: David ANNEQUIN, Les Ollieres Sur Eyrieux (FR)

(73) Assignee: EDMA, Puget-Sur-Argens (FR)

(21) Appl. No.: 19/265,488

(22) Filed: Jul. 10, 2025

(30) Foreign Application Priority Data
Jul. 11, 2024 (FR) 2407626

(51) Int. Cl. B66F 7/02; B66F 17/00

(52) U.S. Cl. CPC B66F 7/02; B66F 17/00

(57) ABSTRACT

The invention proposes a board lifter mechanism that is safe, easy to handle, quiet, rapid and ensures harmonious raising and lowering, without risk of jamming. The device comprises a telescopic mast comprising three segments (12), a chain (20) arranged inside the fixed segment (12) around two pinions (121-122), one of which is driven by a motor, a lower end of the end movable segment being fastened to the chain (20). The segments include respective drive stops so that the mast is deployed and withdrawn depending on the rotation of the chain.

The invention relates to a mechanism for an apparatus for lifting construction boards, to a board-lifting apparatus comprising such a mechanism, and to a method for lifting construction boards using such an apparatus.

In particular, the invention relates to lifting and handling apparatuses that are used during works for handling and positioning heavy objects, such as boards of materials (plasterboard, wood panels, etc.) in order to produce false ceilings or for the fitting out of sloping roofs or partitioning.

This type of apparatus, called board lifter, has the following general structure: a telescopic mast, controllable by a lifting mechanism, is mounted on a rolling stand. A board support is mounted at the end of the mast by way of a pivot mechanism so as to be pivotable between a substantially vertical position for depositing the board thereon, and a substantially horizontal or angular position for fastening the board against a ceiling or a roof slope.

The telescopic mast comprises a first fixed element, and at least one telescopic element that is movable with respect to the fixed element. Generally, the mast comprises two telescopic movable elements.

There are several types of lifting mechanisms.

The most widespread, illustrated in document FR2758150, is a hauling system comprising a winch, several idler pulleys and a cable connected to the winch, passing through the pulleys and through the telescopic elements of the mast.

In order to improve the safety in case the cable breaks, the lifting mechanism comprises a double ratchet winch, connected to a traction (lifting) cable and a safety cable (in case the traction cable breaks) that is slightly less taut than the traction cable. Such a device is also described in document FR3073215.

Nevertheless, this winch mechanism is very noisy: 87 dB (measured using a smartphone known under the name iPhone® with the application known under the name Decibel Ultra®, with 30 cm of the winch, and an ambient noise at 31 dB). Furthermore, the metal cables used wear very rapidly and can either break or fray, risking injury to the user.

Furthermore, since the mechanism is accessible, the risk of a user trapping their fingers is high.

A second type of lifting mechanism is a hybrid mechanism comprising a rack driven by a handwheel by way of a reduction gear system, and a cable reeving system for erecting the telescopic movable elements.

Such a device is described in document WO2016071589.

This mechanism is much quieter and safer than the winch mechanism, since the rack does not wear. Furthermore, it comprises an emergency brake which prevents the mast from falling down if the user releases the brake.

Lastly, the gear system described enables motorized driving by a screwdriver. The latter has to be coupled to the rotation shaft when the user desires motorized actuation. In this case, the user no longer uses the handwheel to lift the mast, but rather the screwdriver. By contrast, they always have to actuate the emergency brake with their other hand. This system therefore requires a certain degree of control familiarity to handle and implement the board lifter.

Another lifting mechanism with motorized actuation has also been disclosed in document EP0969165. This mechanism is also hybrid and comprises an endless screw engaged with one of the telescopic elements of the mast and a motor whose shaft is coupled to the endless screw by way of a set of idler pulleys.

The endless screw is positioned inside the mast, in a coaxial and guided manner inside the telescopic mast.

The endless screw is engaged with a nut bearing secured to the first movable element of the telescopic mast. The second movable element is erected by a cable reeving system which is tensioned when the first movable element raises.

Such a board lifter has a very high weight and bulk due to the size of its motor, which is fixed and remote with respect to the mast, and its return system in order to be able to drive the endless screw.

However, in practice, a board lifter is continually moved so as to pass from one room to another, but also along walls or the ceiling whenever a board has been screwed and the next space needs to be outfitted. The weight and the bulk are therefore very important criteria.

In addition, the engagement zone between the endless screw and the nut bearing secured to the first movable element of the telescopic mast is a critical zone: it can neither be too thin for risk of warping under the weight nor too thick for risk of weighing down the tool excessively. The contact surface between the endless screw and the nut bearing therefore has to be optimal.

This also determines the screw pitch. If a large contact surface is desired, the screw pitch has to be very small. The drawback is that the raising and lowering time will be very long.

Conversely, if rapid raising and lowering is desired, the screw pitch has to be increased, but this reduces the contact surface between the screw and the bearing and makes the device fragile.

Lastly, these devices all comprise cables which may wear, even when they are enclosed in the telescopic movable elements, and which may temporarily jam, adversely affecting the raising and lowering of the mast, and also the safety of the user when the cable suddenly becomes unstuck by the weight of the elements.

The present invention therefore aims to propose a board lifter which is safe, that is to say without risk for the user, but nevertheless easy to handle and actuate by just one user, quiet, rapid, easy to maintain and ensures harmonious raising and lowering, without risk of jamming.

The idea on which the invention is based is to provide a lifting mechanism which is internal to the mast and free of cables through innovative design of the telescopic system of the mast, the movable intermediate segment not being driven by the lifting mechanism, as is conventional.

Another idea is to require the user to use both of their hands to handle and actuate the board lifter, without needing to use one of their hands to actuate an emergency brake.

To this end, a subject of the invention is a lifting mechanism comprising a mast comprising three telescopic segments: a fixed segment, an intermediate segment and an end segment, a chain arranged inside the fixed segment around two pinions, one of which is driven by a motor, a lower end of the end movable segment being fastened to the chain. The segments comprise respective drive stops so that the mast is deployed and withdrawn depending on the rotation of the chain.

More particularly, a subject of the invention is a lifting mechanism for a board lifter, comprising, by reference to the use position:
a telescopic mast comprising a fixed segment, a first telescopic movable segment referred to as “intermediate” segment mounted slidingly inside the fixed segment, and a second telescopic movable segment referred to as “end” segment mounted slidingly inside the intermediate segment;
   characterized in that the lifting mechanism further comprises:
a chain arranged inside the fixed segment and forming a loop engaged around a first pinion arranged at an upper end of the fixed segment and around a second pinion arranged at a lower end of the fixed segment, one of the two pinions being engaged with a control shaft of a means for rotating the shaft, a lower end of the end movable segment being fastened to a strand of the chain;
   and in that:
the fixed segment comprises an upper internal guide stop for guiding the intermediate movable segment during sliding;
the intermediate movable segment comprises a lower external guide stop for guiding against the fixed segment, and an upper internal drive stop; and
the end movable segment comprises a lower external guide stop for parallel guiding of the intermediate movable segment, and an upper external lifting stop for lifting the intermediate movable segment.

According to other embodiments:
the fixed segment may comprise a peripheral tubular part which has a lower end and an upper end and in which a profiled element having an open face and passing beyond the upper end of the tubular part by a determined height is centrally fastened, the first pinion being arranged at an upper end of the profiled element, and the second pinion being arranged at a lower end of the profiled element, the end movable segment being arranged, as seen in cross section, around and near the profiled element, and the intermediate movable segment being arranged between the end movable segment and the fixed segment;
the means for rotating the control shaft may be an electric motor connected to a power supply;
the lifting mechanism may further comprise a control station which is arranged outside the fixed segment and comprises two handles, one for each hand of the user, each handle comprising at least one control for the electric motor that is actuatable by just one finger while the rest of the user's hand remains engaged with the handle, the control station comprising at least one control for extending/retracting the mast at a first speed, and a control for extending/retracting the mast at a second speed lower than the first speed for a minute adjustment;
the electric motor may be connected to the control shaft by way of a speed regulator possibly combined with a reducer;
the motor may be arranged at the lower end of the fixed segment and connected to the control shaft of the second pinion;
the power supply may comprise a fixed base and a removable battery, the base being electrically connected to the electric motor and the battery comprising a system for connection to the base so as to enable a battery change;
the lifting mechanism may further comprise an end-of-travel sensor arranged to detect the member for fastening the chain to the first telescopic movable segment near one or each pinion;
the lifting mechanism may further comprise a force sensor arranged to reversibly cut off the supply of the motor in a direction of rotation for extending the mast when a compressive force greater than a determined threshold is detected;
the force sensor may be a torque limiter arranged on at least one of the pinions of the chain, and capable of cutting off the supply of the motor when a torque greater than a predetermined threshold is reached.

A further subject of the invention is a board lifter for lifting a construction board, characterized in that it comprises:
a preceding mechanism,
a rolling stand fastened to the lower end of the fixed segment of said mechanism;
a board holder pivotably mounted at an upper end of the end movable segment of the mechanism.

According to other embodiments:
the stand may comprise at least three legs, of which at least two legs are mounted pivotably between a use position, in which the legs are spaced apart from one another so as to ensure the stability of the board lifter, and a transport position, in which the pivotable legs are folded up near one another;
the end of the mast may comprise two castors arranged such that they do not touch the ground when the legs of the stand are in the use position, and such that they touch the ground when the legs are in the transport position;
two adjacent legs may comprise a pair of wheels, a first wheel being arranged near the mast and a second wheel being arranged near a free end of the leg, the wheels near the mast being arranged so as to support the weight of the apparatus in order to transport it by rolling when the legs are in the transport position.

A further subject of the invention is a method for implementing a preceding lifting apparatus, comprising the following steps:
a) providing a preceding board lifter;
b) placing a board on the board holder;
c) gripping in each hand a handle of the control station and positioning the apparatus at a suitable location for the board;
d) actuating with a finger a control for the electric motor while keeping the rest of the hand on the handle, until the telescopic mast is deployed and the board is in the fastening position;
e) releasing the control;
f) fastening the board;
g) actuating with a finger a control for the electric motor while keeping the rest of the hand on the handle, until the telescopic mast is withdrawn by rotation of the chain, progressively and in a controlled manner.

Further features of the invention will be set out in the detailed description below, given with reference to the attached drawings in which, respectively:

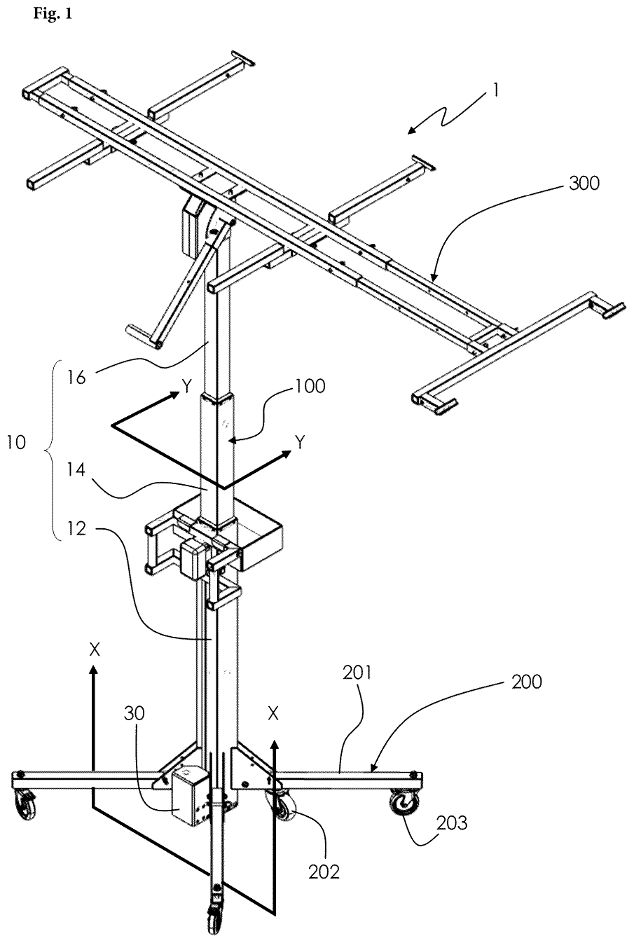

FIG. 1 depicts a general schematic perspective view of a board lifter provided with a lifting mechanism and with a control station according to the invention;

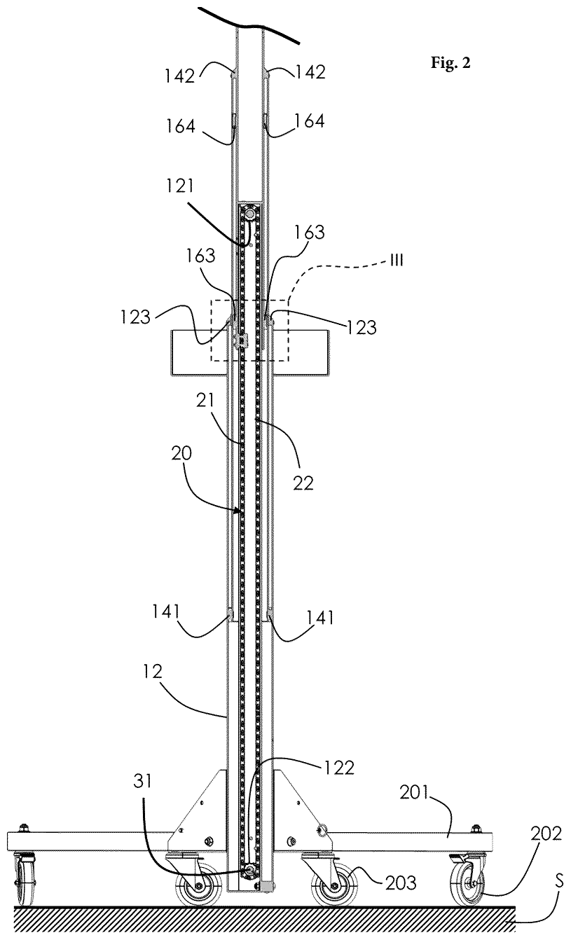

FIG. 2 depicts a partial schematic plan view in frontal section along line X-X of the board lifter in FIG. 1 and showing the lifting mechanism according to the invention;

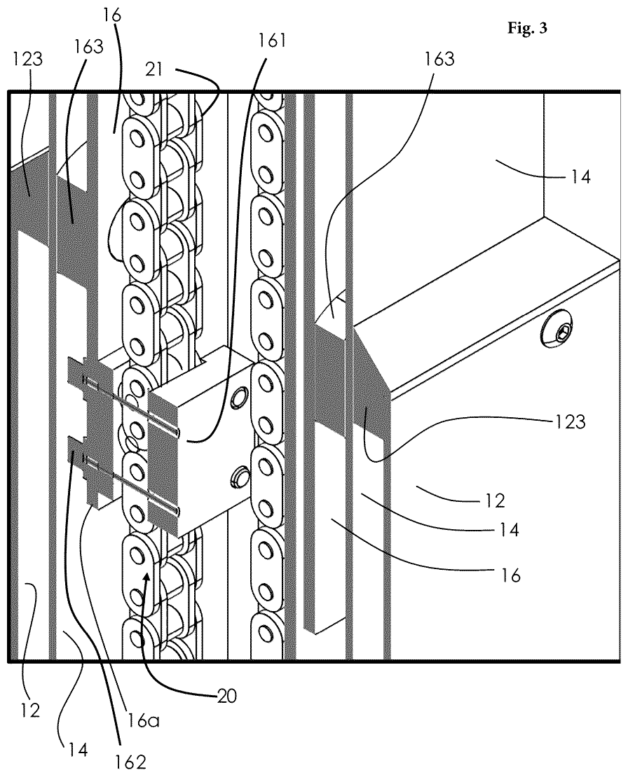

FIG. 3 depicts a partial schematic perspective view in frontal section along line X-X of an enlargement of the mechanism in FIG. 2 at the fastening between the chain rotatably mounted on the fixed segment and the end movable segment;

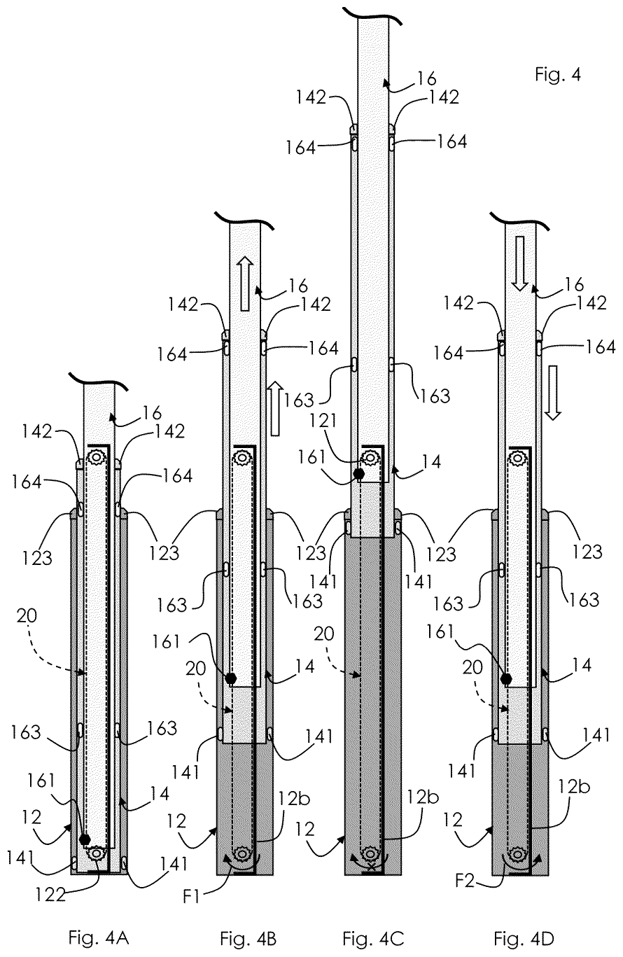

FIG. 4 depicts four partial schematic views in frontal section along line X-X of the mechanism in FIG. 2, respectively in a rest position, in an intermediate deployment position, in a deployed position and in an intermediate withdrawal position;

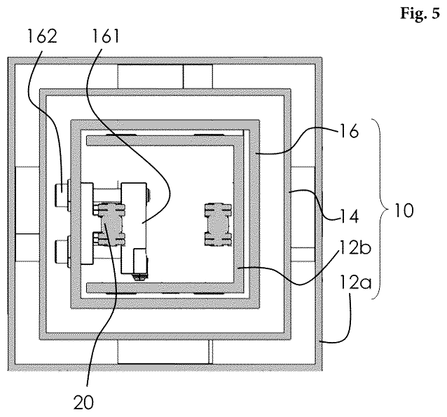

FIG. 5 depicts a schematic view in cross section along line Y-Y of the board lifter according to the invention, seen from above and illustrating the fitting of the different segments of the mast;

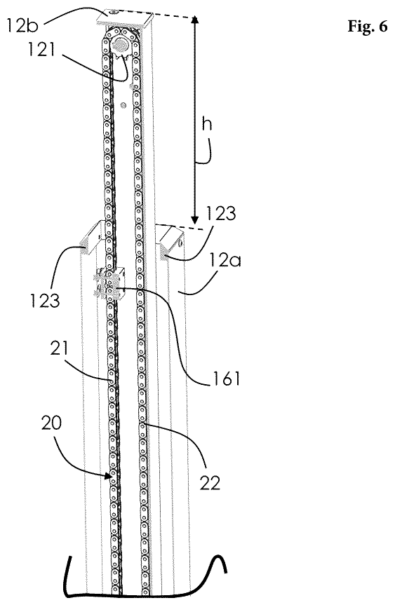

FIG. 6 depicts a schematic perspective view in frontal section along line X-X of the upper part of the fixed segment of a board lifter according to the invention;

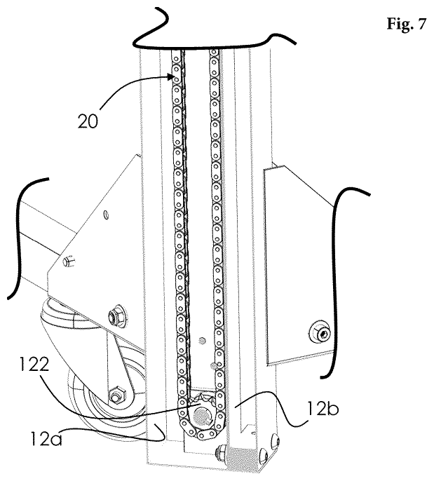

FIG. 7 depicts a schematic perspective view in frontal section along line X-X of the lower part of the fixed segment of a board lifter according to the invention;

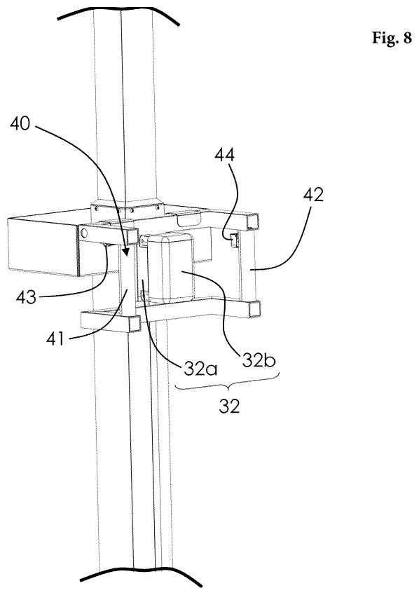

FIG. 8 depicts a partial schematic perspective view, seen from a first side of one exemplary embodiment of a control station according to the invention; and

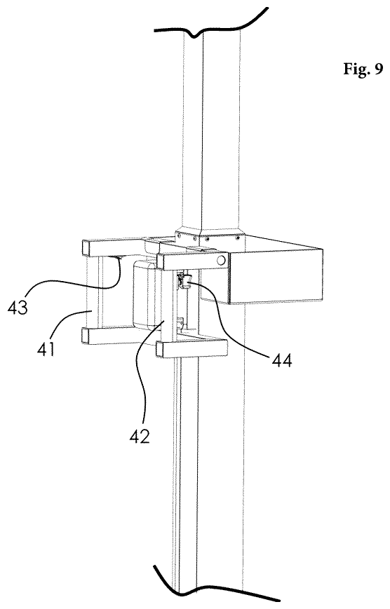

FIG. 9 depicts a partial schematic perspective view, seen from a second side of the control station according to the invention in FIG. 8.

FIG. 1 illustrates a board lifter provided with a lifting mechanism according to the invention in the use position. The board lifter 1 comprises a lifting mechanism 100, a rolling stand 200 fastened to the lower end of the fixed segment of said mechanism 100 (see below), and a board holder 300 pivotably mounted at an upper end of the end movable segment of the mechanism 100.

The lifting mechanism 100 according to the invention comprises a telescopic mast 10 comprising a fixed tubular segment 12 intended to be secured to the rolling stand 200, a first telescopic movable tubular segment 14, referred to as “intermediate” segment, mounted slidingly inside the fixed segment 12, and a second telescopic movable tubular segment 16, referred to as “end” segment, mounted slidingly inside the intermediate segment 14.

The lifting mechanism 100 also comprises a chain 20 (visible in FIGS. 2 to 6), arranged inside the fixed segment 12.

As shown in FIG. 2, which illustrates the normal use position, on the ground S, of a board lifter 1 equipped with the lifting mechanism 100, the fixed tubular segment 12 comprises, fastened to an inner face, a first pinion 121 arranged at an upper end and a second pinion 122 arranged at a lower end. One of the two pinions 121-122 is engaged with a control shaft 31 of a means 30 (for example an electric motor 30) for rotating said control shaft 31.

More particularly, and preferably, it is the second pinion 122, in the lower position, which is engaged with the control shaft. The latter is preferably the control shaft 31 of an electric motor, said control shaft being arranged near the lower end of the fixed segment 12 (and therefore of the mast), making it possible to lower the centre of gravity of the assembly.

The chain 20 forms a loop engaged around the first pinion 121 and the second pinion 122. The two chain portions arranged between the pinions are hereinafter called chain strands.

According to the invention, and as illustrated in enlarged form in FIG. 3, a lower end 16a of the end movable tubular segment 16 is fastened to only one 21 of the two strands of the chain 20. In the example illustrated, this fastening is effected by means of a bracket 161 engaged with a link of the chain 20 and screwed by screws 162 to the end movable tubular segment 16.

FIG. 2 also illustrates the different stops which equip the segments 12-14-16 of the mast 10, and which contribute to its deployment without cables, simply by means of the chain 20.

Thus, the fixed segment 12 comprises an upper internal guide stop 123 (since it faces towards the inside of the segment bearing it on an inner face) for guiding the intermediate movable segment 14 during sliding. This internal stop 123 slides along the outer faces of the intermediate movable segment 14 and ensures a substantially constant spacing between the fixed segment 12 and the intermediate movable segment 14 during deployment.

Similarly, the intermediate movable segment 14 comprises an external lower guide stop 141 (since it faces towards the outside of the segment bearing it on an outer face) for guiding against the fixed segment 12 and which slides along the inner faces of the fixed segment 12. The intermediate movable segment 14 also comprises an upper internal drive stop 142 which slides along the outer faces of the second end segment 16 during deployment of the mast 10.

Lastly, the end movable segment 16 comprises a lower external guide stop 163 for parallel guiding of the intermediate movable segment 14, and an upper external lifting stop 164 for lifting the intermediate movable segment 14 when it comes into contact with the upper internal drive stop 142 for driving the intermediate movable segment 14.

These different stops 123, 141, 142, 163, 164 may be peripheral, or in several parts (for example in the form of plastic washers) on two, three or four sides of the segment bearing them. This makes it possible to ensure that the segments 12-14-16 are centred in pairs with respect to one another.

FIG. 4 illustrates the operation of the mechanism according to the invention, and in particular the role of the chain 20 (illustrated in dashed lines) and of the stops 123, 141, 142, 163, 164 in the kinematics for deployment and withdrawal of the mast.

Four stages of deployment are illustrated: in 4A, the mechanism is in a rest, that is to say non-extended, position; in 4B, the mechanism is being deployed; in 4C, the mechanism has been fully deployed; and in 4D, the mechanism is being withdrawn.

At rest, in 4A, the two movable segments of the mechanism are in the lower position. The means 161 for fastening the end movable segment to the chain 20 is also in the lower position, near, or even in abutment against, the lower second pinion 122. The latter may therefore advantageously serve as a mechanical stop for the rest position of the end movable segment 16.

The lower 163 and upper 164 external stops of the end movable segment 16 ensure the parallelism between the end movable segment 16 and the intermediate movable segment 14.

Similarly, the lower external stop 141 of the intermediate movable segment 14 and the upper internal stop 123 of the fixed segment 12 ensure the parallelism between the fixed segment 12 and the intermediate movable segment 14.

During movement, the stops 123, 141, 163 and 164 ensure the parallel guidance of the segments with respect to one another.

When the lifting mechanism is activated, in 4B, the second pinion 122 is driven by the motor in the direction of the arrow F1. Since the fastening means 161 is secured to one 21 of the strands 21-22 of the chain 20, it raises and drives the end movable segment 16 upwards, sliding with respect to the intermediate movable segment 14.

During the raising of the end movable segment 16, its upper external stop 164 comes into contact with the upper internal stop 142 of the intermediate movable segment 14, thereby forcing the lifting of the intermediate movable segment 14 which raises at the same time as the end movable segment 16.

The lifting mechanism according to the invention has been fully deployed, in 4C, when, for example, the means 161 for fastening the end movable segment 16 to the chain 20 comes into abutment against the upper first pinion 122, thereby stopping the rotation of the chain and the raising of the end movable segment 16 and of the intermediate movable segment 14.

In order to avoid dangerous contact between the fastening means 161 and the pinions 121-122 during raising and lowering, the lifting mechanism according to the invention may advantageously comprise an end-of-travel sensor arranged to detect the member for fastening the chain to the first telescopic movable segment near one or each pinion.

As an alternative or in combination, in order to avoid damaging the board lifter when the fastening height of the piece of plasterboard is lower than the maximum height of deployment of the mechanism, the lifting mechanism according to the invention may advantageously comprise a force sensor arranged to reversibly cut off the supply of the motor in a direction of rotation F1 for extending the mast when a compressive force greater than a determined threshold is detected. Thus, the supply of the motor is cut off if the head fastened to the end movable segment 16 is in contact with the ceiling.

In one exemplary embodiment, the force sensor may be a torque limiter arranged on at least one of the pinions of the chain, and capable of cutting off the supply of the motor when a torque greater than a predetermined threshold is reached.

When the lifting mechanism according to the invention has been fully deployed, the intermediate movable segment 14 serves as a mechanical relay between the fixed segment 12 and the end movable segment 16, that is to say that it ensures the mechanical continuity between these two segments which just have a driving role in the lifting. It thus ensures the rigidity of the mast.

During lowering, in 4D, the lower pinion 122 is driven in the direction of the arrow F2, opposite the direction of the arrow F1.

The fastening means 161 then lowers, leading to the lowering of the end movable segment 16.

The intermediate movable segment 14 also lowers by gravity, under the effect of its own weight, down to the rest position identical to the situation in 4A.

Thus, according to the invention, only the fixed segment 12 and the end movable segment 16 are connected by the driving chain 20. The intermediate segment 14 is, for its part, mounted with the ability to slide freely between these segments, and is caused to raise or lower only when its upper internal stop 142 is in contact with the upper external stop 164 of the end movable segment 16.

The lifting mechanism according to the invention therefore enables a limited bulk since the pinions 121-122 and the chain 20 are housed inside the fixed segment 12 of the mast 10. Furthermore, the lifting mechanism is free of cables and therefore has increased reliability with respect to the prior art.

Since only the end movable segment 16 and the fixed segment 12 are driven with respect to one another, they determine the lifting height.

In the case of a board lifter, it is nevertheless necessary to ensure a loading height (therefore in the rest position) for the board on the head 300 that is compatible with the size of an average person. The length of the end movable segment 16 and the length of the fixed segment 12 are therefore limited.

According to an advantageous embodiment of the invention, illustrated in more detail in FIGS. 5 to 7, the fixed segment 12 comprises a peripheral tubular part 12a which has a lower end and an upper end and in which a profiled element 12b passing beyond the upper end of the tubular part 12a by a determined height h is centrally fastened.

The first pinion 121 is arranged at an upper end of the profiled element 12b, and the second pinion 122 is arranged at a lower end of the profiled element 12b.

The latter furthermore has an open face so as to enable the raising and lowering of the means 161 for fastening the end movable segment 16 to the chain 20.

The profiled element 12b has many benefits. First of all, it makes it possible to have a first pinion 121 arranged at an upper end of the profiled element 12b, at a height greater than the height of the peripheral tubular part 12a.

Furthermore, it makes it possible to protect the chain 20 inside the fixed segment 12 by preventing any jolt of the movable segments 14-16 against the chain 20.

Lastly, it serves as a guide for the movable segments during the raising of the board lifter.

Thus, as shown in FIG. 5, seen in cross section along line Y-Y, the end movable segment 16 is arranged around and near the profiled element 12b (which has a U-shaped section, the open face of which enables the progress of the fastening means 161). The intermediate movable segment 14 is, for its part, arranged around and near the end movable segment 16, and the tubular part 12a of the fixed segment 12 is arranged around and near the intermediate movable segment 14.

In other words, the intermediate movable segment 14 is arranged between the end movable segment 16 and the tubular part 12a of the fixed segment 12.

“Near” is understood as meaning that the segments are spaced apart from one another by the thickness of the stops described above.

This arrangement is particularly advantageous since the segments are not in direct contact with one another, which would entail a very large contact surface, and therefore a very powerful motor. The only contact surface is that of the stops, thereby reducing friction considerably and necessitating only a small force for the driving of the mechanism.

This makes it possible for the means for rotating the control shaft 31 to be an electric motor 30 connected to a power supply 32 of modest power. For example, this power supply may comprise a fixed base 32a on the mast and a removable battery 32b of the interchangeable battery type for a portable electrical device of the screwdriver type (see FIGS. 8 and 9).

In this case, the base 32a is electrically connected to the electric motor 30 and the battery 32b comprises a system for connection to the base so as to enable a battery change. This type of structure is known to those skilled in the art in the field of portable electrical devices and will be able to be adapted to the lifting mechanism according to the invention without difficulty.

Advantageously, the electric motor is connected to the control shaft 31 by way of a speed regulator possibly combined with a reducer.

According to another aspect of the invention, the lifting mechanism according to the invention comprises a control station 40 which is arranged outside the fixed segment 12 and comprises two handles 41-42, one for each hand of the user.

Each handle 41-42 comprises at least one control 43-44 for the electric motor 30 that is actuatable by just one finger while the rest of the user's hand remains engaged with the handle.

In the embodiment illustrated, two types of control are illustrated.

The control 43 is, for example, a pushbutton with three positions, Raise-OFF-Lower, and the control 44 is a trigger provided with a return means and capable of controlling the motor according to a continuous range.

The control station thus preferably comprises at least one control for extending/retracting the mast at a first speed (in this case the control 43), and a control for extending/retracting the mast at a second speed, lower than the first speed, for a minute adjustment (in this case the trigger 44).

The implementation of a board lifter equipped with a lifting mechanism according to the invention comprises the following steps:
a1) providing a board lifter equipped with a lifting mechanism provided with a preceding control station 40, and ensuring that it is in the rest position (see situation 4A in FIG. 4);
b1) placing a board, of the BA13 type for example, on the board holder 300;
c1) gripping in each hand a handle 41-42 of the control station 40 and positioning the apparatus at a suitable location for the board by rolling it along the ground S;
d1) actuating with a finger at least one control 43-44 for the electric motor 30 while keeping the rest of the hand on the handle, until the telescopic mast is deployed and the board is in the fastening position;
e1) releasing the control 43-44;
f1) fastening the board;
g1) actuating with a finger a control 43-44 for the electric motor 30 while keeping the rest of the hand on the handle, until the telescopic mast is withdrawn by rotation of the chain, progressively and in a controlled manner.

It can then be started again to fasten another board.

In this way, the user is able to handle the board lifter in order to position it as desired, and, possibly concomitantly, to control its operation, with both of their hands, without releasing it. This prevents them from being injured and enables very precise positioning of the board by raising/moving the board lifter.

Such a mechanism makes it possible to erect the telescopic mast rapidly and without effort, in particular by virtue of the use of a motor and of a very ergonomic control station which makes it possible to simultaneously perform the movement function and the deployment function.

Lastly, this lifting mechanism is extremely quiet compared with the ratchet winch systems.

The lifting mechanism according to the invention is therefore very quiet, safe, reliable and space-saving.

According to other aspects of the invention:

The stand 200 may be conventional. Advantageously, as illustrated in FIGS. 1 and 2, the stand 200 may comprise at least three legs 201, of which at least two legs are mounted pivotably between a use position, in which the legs are spaced apart from one another so as to ensure the stability of the board lifter, and a transport position, in which the pivotable legs are folded up near one another, in this case against the mast.

The end of the mast preferably comprises two castors arranged such that they do not touch the ground when the legs of the stand are in the use position, and such that they touch the ground when the legs are in the transport position. These castors allow the board lifter to be rolled in cantilevered fashion, in the transport position with the legs 201 folded. In a preferred embodiment, two adjacent legs 201 each comprise a pair of wheels: a first wheel 202 arranged near the mast and a second wheel 203 arranged near a free end of the leg. The wheels 202 near the mast are arranged so as to support the weight of the apparatus in order to transport it by rolling when the legs are in the transport position.

1. Lifting mechanism (100) for a board lifter, comprising, by reference to the use position:
a telescopic mast (10) comprising a fixed segment (12), a first telescopic movable segment referred to as “intermediate” segment (14) mounted slidingly inside the fixed segment (12), and a second telescopic movable segment referred to as “end” segment (16) mounted slidingly inside the intermediate segment (14);
characterized in that the lifting mechanism (100) further comprises:
a chain (20) arranged inside the fixed segment (12) and forming a loop engaged around a first pinion (121) arranged at an upper end of the fixed segment (12) and around a second pinion (122) arranged at a lower end of the fixed segment (12), one of the two pinions being engaged with a control shaft (31) of a means (30) for rotating the shaft, a lower end (16a) of the end movable segment (16) being fastened to a strand (21) of the chain (20);
and in that:
the fixed segment (12) comprises an upper internal guide stop (123) for guiding the intermediate movable segment (14) during sliding;
the intermediate movable segment (14) comprises a lower external guide stop (141) for guiding against the fixed segment, and an upper internal drive stop (142); and
the end movable segment (16) comprises a lower external guide stop (163) for parallel guiding of the intermediate movable segment (14), and an upper external lifting stop (164) for lifting the intermediate movable segment.

2. Lifting mechanism (100) according to claim 1, wherein the fixed segment (12) comprises a peripheral tubular part (12a) which has a lower end and an upper end and in which a profiled element (12b) having an open face and passing beyond the upper end of the tubular part (12a) by a determined height (h) is centrally fastened, the first pinion (121) being arranged at an upper end of the profiled element (12b), and the second pinion (122) being arranged at a lower end of the profiled element (12b), the end movable segment (16) being arranged, as seen in cross section, around and near the profiled element (12b), and the intermediate movable segment (14) being arranged between the end movable segment (16) and the fixed segment (12).

3. Lifting mechanism (100) according to claim 1, wherein the means for rotating the control shaft is an electric motor (30) connected to a power supply.

4. Lifting mechanism (100) according to claim 3, further comprising a control station (40) which is arranged outside the fixed segment (12) and comprises two handles (41-42), one for each hand of the user, each handle comprising at least one control (43-44) for the electric motor (30) that is actuatable by just one finger while the rest of the user's hand remains engaged with the handle, the control station (40) comprising at least one control for extending/retracting the mast at a first speed, and a control for extending/retracting the mast at a second speed, lower than the first speed, for a minute adjustment.

5. Lifting mechanism (100) according to claim 1, wherein the electric motor (30) is connected to the control shaft (31) by way of a speed regulator possibly combined with a reducer.

6. Lifting mechanism (100) according to claim 4, wherein the motor (30) is arranged at the lower end of the fixed segment (12) and connected to the control shaft (31) of the second pinion (122).

7. Lifting mechanism (100) according to claim 4, wherein the power supply comprises a fixed base and a removable battery, the base being electrically connected to the electric motor and the battery comprising a system for connection to the base so as to enable a battery change.

8. Lifting mechanism (100) according to claim 4, further comprising an end-of-travel sensor arranged to detect the member for fastening the chain to the first telescopic movable segment near one or each pinion.

9. Mechanism according to claim 4, further comprising a force sensor arranged to reversibly cut off the supply of the motor in a direction of rotation for extending the mast when a compressive force greater than a determined threshold is detected.

10. Lifting mechanism (100) according to claim 9, wherein the force sensor is a torque limiter arranged on at least one of the pinions of the chain, and capable of cutting off the supply of the motor when a torque greater than a predetermined threshold is reached.

11. Board lifter (1) for lifting a construction board, characterized in that it comprises:
a mechanism (100) according to claim 1,
a rolling stand (200) fastened to the lower end of the fixed segment (12) of said mechanism (100);
a board holder (300) pivotably mounted at an upper end of the end movable segment (16) of the mechanism (100).

12. Board lifter according to claim 11, wherein the stand (200) comprises at least three legs (201), of which at least two legs are mounted pivotably between a use position, in which the legs are spaced apart from one another so as to ensure the stability of the board lifter, and a transport position, in which the pivotable legs are folded up near one another.

13. Board lifter according to claim 11, wherein the end of the mast comprises two castors arranged such that they do not touch the ground when the legs (201) of the stand (200) are in the use position, and such that they touch the ground when the legs are in the transport position.

14. Board lifter according to claim 12, wherein two adjacent legs comprise a pair of wheels, a first wheel (202) being arranged near the mast and a second wheel (203) being arranged near a free end of the leg (201), the wheels (202) near the mast being arranged so as to support the weight of the apparatus in order to transport it by rolling when the legs (201) are in the transport position.

15. Method for implementing a board lifter comprising:
a1) providing a board lifter (1) according to claim 11, wherein the means for rotating the control shaft is an electric motor (30) connected to a power supply, the mechanism further comprising a control station (40) which is arranged outside the fixed segment (12) and comprises two handles (41-42), one for each hand of the user, each handle comprising at least one control (43-44) for the electric motor (30) that is actuatable by just one finger while the rest of the user's hand remains engaged with the handle, the control station (40) comprising at least one control for extending/retracting the mast at a first speed, and a control for extending/retracting the mast at a second speed, lower than the first speed, for a minute adjustment;
b1) placing a board on the board holder;
c1) gripping in each hand a handle (41-42) of the control station (40) and positioning the apparatus at a suitable location for the board;
d1) actuating with a finger a control (43-44) for the electric motor (30) while keeping the rest of the hand on the handle, until the telescopic mast is deployed and the board is in the fastening position;
e1) releasing the control;
f1) fastening the board;
g1 actuating with a finger a control (43-44) for the electric motor (30) while keeping the rest of the hand on the handle, until the telescopic mast is withdrawn by rotation of the chain (20), progressively and in a controlled manner.
